(19) United States
(12) Patent Application Publication
(10) Pub. No.: US 2024/0000118 A1
(43) Pub. Date: Jan. 4, 2024

(54) PLANT - BASED EGG LIQUID FORMULATIONS AND PROCESSES THEREOF

(71) Applicant: Aboli Ashish Jogi, Mumbai (IN)

(72) Inventor: Aboli Ashish Jogi, Mumbai (IN)

(21) Appl. No.: 18/252,762

(22) PCT Filed: Nov. 13, 2021
(86) PCT No.: PCT/IN2021/051069

§ 371 Date: May 15, 2023

(30) Foreign Application Priority Data
Nov. 14, 2020 (IN) 202021044798

(51) Int. Cl. A23L 15/00; A23L 33/185; A23L 33/115; A23L 29/10; A23L 27/00; A23L 29/00; A23L 5/43; A23L 3/3508; A23L 33/175; A23L 33/155; A23L 33/145; A23J 3/16; A23J 3/14

(52) U.S. Cl. CPC A23L 15/35; A23L 33/185; A23L 33/115; A23L 29/10; A23L 27/88; A23L 29/06; A23L 5/43; A23L 3/3508; A23L 33/175; A23L 33/155; A23L 33/145; A23J 3/16; A23J 3/14

(57) ABSTRACT

The present disclosure relates to plant-based egg liquid formulations and processes thereof, in particular plant protein-based egg liquid formulations and processes thereof. The plant-based egg liquid formulation comprises at least two plant proteins in the range of 4 to 30% selected from mung bean protein, soy protein, chickpea protein, pea proteins (yellow pea, green peas), fawa bean, bengal gram, black gram, amaranth protein, mushroom or combinations thereof, edible oil in the range of 3 to 25% selected from peanut oil, palm oil, soya oil, rice bran oil, sunflower oil, mustard oil, canola oil or combinations thereof; emulsifiers in the range of 0.1% to 3% selected from xanthan gum. guar gum, gellan gum, acacia gum, methyl cellulose, tapioca syrup, lecithin, soy lecithin, Locust Bean Gum, tamarind gum, modified starch, or combinations thereof; salts in the range of 0.1% to 3% selected from a mixture of pink salt, black salt, table salt, tricalcium phosphate, tetra sodium pyrophosphate, potassium citrate; taste enhancers in the range of 0.05% to 2% selected from vegan nutritional yeast extract, vegan egg flavor, sugar, dried powder or pastes of onion, garlic, or combinations thereof. The formulation can be used to make baked food product, sauce, dressing, mayonnaise, custard, scramble, omelet, ice cream, pasta, burger, patty and certain other dishes.

### CROSS-REFERENCE TO RELATED APPLICATIONS

The present application is a § 371 National Phase entry of International Application No. PCT/IN2021/051069, filed Nov. 13, 2021, which claims priority to Indian Patent Application No. 202021044798, filed Nov. 14, 2020, the contents of each of which are hereby incorporated by reference in their entirety.

### FIELD OF THE INVENTION

The present disclosure relates to a plant-based egg liquid formulation and process for preparing the same and use thereof.

### BACKGROUND AND PRIOR ART

Egg as food has been known since time immemorial. The most commonly consumed eggs as food diet are chicken or hen eggs, generally referred as poultry eggs or shell eggs. However, poultry eggs/shell eggs contain undesired nutrients like cholesterol and saturated fats which are the cause of many ailments in human beings. Further, poultry eggs/shell eggs are associated with the negatives of animal farming such as cruelty to animals and harm to environment. Another, disadvantage associated with poultry eggs/shell eggs is the use of antibiotics in curbing infectious diseases like flu, etc.

Therefore, there is a growing interest in plant-based eggs as it offers customized nutritional and health food to address human dietary needs and at the same time reduces the risk of cardiovascular disease. Plant-based eggs are one such dietary replacements which provide superior or equivalent functionality egg. Plant-based eggs are used as thickener in the bakery, confectionery, beverages, etc. However, are not found suitable for cooking products like omelette/scramble eggs.

Another alternative involves use of Just Inc's Plant Based Egg Liquid to the overcome poultry eggs/shell eggs associated drawbacks. It comes in a liquid form in bottles which can be readily used to cook omelette and scramble eggs like a normal hen egg. However, the solution provided by Just Inc's Plant Based Egg Liquid is not cost effective from consumer point of view. Also, the liquid egg alternative does not provide additional nutrients/micro-nutrients for supplementing the diet.

Yet another, plant-based egg substitute is disclosed in US20140356507A1. This document discloses composition comprising protein in an amount up to 80% by dry weight, and fat in amount from 5% to 15% by dry weight. The said composition is essentially egg-free, and provides binding, moisturizing, leavening, and/or emulsifying properties similar to an egg.

Another egg substitute composition is disclosed in WO2015170172A1. The composition comprises of proteins, fats, binding agents, emulsifiers, enzymes, thickening agents, and mineral salts. The composition having a hydration ratio from about 1:4 (egg replacement composition: water) to about 1:6 (egg replacement composition: water).

Although, egg substitute composition known in the art has met with some success. However, the problems associated with the shelf life of compositions due to the nature of proteins, adequate taste and texture of egg prepared from egg compositions along with enhanced functionalities and cost-effective manufacturing process still exists.

In view of the foregoing, there is a need for an Egg formulation which meet the requirements of adequate taste and texture of egg prepared and comprises additional nutrients/micro-nutrients for supplementing the diet. Further, the egg formulation should be able to be manufactured in a cost-effective manner.

The present inventors have surprisingly found plant-based egg liquid formulation and a method of preparing the same which addresses problems associated with the art, as discussed above. The egg formulation utilizes plant-based proteins in an efficient cost-effective way. Further, the egg formulations of the present invention are found to be safe and can be well preserved for sufficiently long time.

### OBJECTS OF THE INVENTION

The main object of the present invention is to provide plant-based egg liquid formulations, particularly plant protein based.

Yet another objective of the present invention is to provide a method of preparing plant-based egg liquid formulations.

Yet another objective of the present invention is use of the plant protein-based egg liquid formulations for making baked food product, sauce, dressing, mayonnaise, custard, scramble, omelette, ice cream, pasta, burger, patty, and certain other dishes.

### SUMMARY OF THE INVENTION

The present invention provides plant-based egg liquid formulations comprising at least two plant proteins, edible oil, emulsifier, salts and taste enhancers. Further, the plant-based egg liquid formulation comprises flavors, micro-nutrients, enzyme, colorant and preservatives.

Further, a method of preparing the said formulation is disclosed in the present invention.

Also, plant protein-based egg liquid formulation is used for making food products selected from baked food product, sauce, dressing, mayonnaise, custard, scramble, omelette, ice cream, pasta, burger, patty, and certain other dishes.

### DETAILED DESCRIPTION

The present disclosure relates to plant-based egg liquid formulations. The formulation comprises at least two plant proteins, edible oil, emulsifier, salts, and taste enhancers. The plant-based egg liquid formulation of the present invention further comprises flavors, micro-nutrients, enzyme, colorant and preservatives. The formulation can be used to make baked food product, sauce, dressing, mayonnaise, custard, scramble, omelette, ice cream, pasta, burger, patty, egg scramble, and certain other dishes etc.

The terms “comprises”, “comprising”, or any other variations thereof, are intended to cover a non-exclusive inclusion, that comprises a list of components and does not include only those components but may include other components not expressly listed or inherent to said composition. In other words, one or more elements in a composition/method proceeded by “comprises” does not, without more constraints, preclude the existence of other elements or additional elements in the composition/formulation/method.

### Formulations and its Method of Preparation

In one embodiment of the present invention, the plant-based egg liquid formulations comprise the components preferably in the following range:

At least two plant proteins in the range of 4 to 30%

Edible oil in the range of 3 to 25%;

Emulsifiers in the range of 0.1% to 3%;

Salts in the range of 0.1% to 3%;

Taste enhancers in the range of 0.05% to 2%.

In another embodiment of the present invention, the plant-based egg liquid formulation comprising: at least two plant proteins in the range of 4 to 30% selected from mung bean protein, soy protein, chickpea protein, pea proteins (yellow pea, green peas), fawa bean, bengal gram, black gram, amaranth protein, mushroom or combinations thereof,
edible oil in the range of 3 to 25% selected from peanut oil, palm oil, soya oil, rice bran oil, sunflower oil, mustard oil, canola oil or combination thereof;
emulsifiers in the range of 0.1% to 3% selected from xanthan gum, guar gum, gellan gum, acacia gum, methyl cellulose, tapioca syrup, lecithin, soy lecithin, Locust Bean Gum, tamarind gum, modified starch, or combination thereof;
salts in the range of 0.1% to 3% selected from a mixture of pink salt, black salt, table salt, tricalcium phosphate, tetra sodium pyrophosphate, potassium citrate;
taste enhancers in the range of 0.05% to 2% selected from vegan nutritional yeast extract, vegan egg flavor, sugar, dried powder or pastes of onion, garlic, or combination thereof.

In yet another embodiment of present invention, the plant-based egg liquid formulation further comprises flavors, micro-nutrients, enzyme, colorant and preservatives.

In yet another embodiment of present invention, the plant proteins is preferably in the form of an isolate, concentrate, hydroisolate and/or peptides but not limited to this.

In yet another embodiment of present invention, the colorant is selected from, but not limited to turmeric, curcumin, and any other natural or food colorant or combination thereof.

In yet another embodiment of present invention, the preservative is selected from, but not limited to this, potassium sorbate, sodium benzoate, calcium propionate or combination thereof.

In yet another embodiment of present invention, the micro-nutrients are selected from but not limited to this, Vitamin A, Vitamin E, Vitamin C, Vitamin D, Vitamin K, Vitamin B1, Vitamin B12, Vitamin B6, BCAA (branch-chain amino acids) or combination thereof.

In yet another embodiment of present invention, the BCAA composition is L-leucine, L-isoleucine and L-valine in a ratio of 2:1:1.

In yet another embodiment of present invention, the plant-based egg liquid formulation comprising: at least two plant proteins selected from mung bean protein, chickpea protein, soy protein, pea protein in the range of 10-25%;
edible oils selected from sunflower oil, rice bran oil, canola oil or combination thereof in the range of 5-20%;
emulsifiers selected from gellan gum, tapioca syrup, lecithin or combination thereof in the range of 0.2-2%;
salts selected from the mixture of black salt, pink salt, table salt, tricalcium phosphate, tetra sodium pyrophosphate, potassium citrate in the range of 0.1-2%
taste enhancers selected from onion powder, garlic powder, vegan egg flavour, sugar, vegan nutritional yeast extract or combination thereof in the range of 0.01-0.3%
colorant selected from curcumin, turmeric or combination thereof in the range of 0.01-0.06% preservatives selected from potassium sorbate, sodium benzoate, calcium propionate or combination thereof in the range of 0.01-2%; and
transglutaminase as an enzyme in the range of 0.0003-0.003%.

In yet another embodiment of present invention, the plant-based egg liquid formulation comprising: mung bean protein about 13%; pea protein about 0.34%; sunflower oil about 8.90%; gellan gum about 0.101%, tapioca syrup about 0.06%; table salt about 0.178%, black salt about 0.1%, sugar about 0.38%, onion powder about 0.115, garlic powder about 0.02%, potassium sorbate 0.318%, sodium benzoate about 0.044%, tetra sodium pyrophosphate about 1.34%, yeast extract about water 75.5%; vitamin A about 270 mcg, vitamin B1 about 400 mcg, vitamin B2 about vitamin B12 about 0.16 mcg, vitamin D about 1 IU and branched chain amino acid about

In yet another embodiment of present invention, the plant-based egg liquid formulation comprising: mung bean protein about 10.63%; soy protein about 2.13%, chickpea protein about 0.43%; sunflower oil about 4.25%; gellan gum about 0.64%, tapioca syrup about 2.13%; lecithin about 2.34%; table salt about 0.21%, black salt about 0.13%, onion powder about 0.78%, potassium sorbate 0.26%, sodium benzoate about 1.81%,tricalcium phosphate about 1.81%, yeast extract about 0.21%; water 72%; Transglutaminase enzyme about 0.002% and branched chain amino acid about 0.21 mg.

In yet another embodiment of present invention, the edible oil of the formulation preferably provides fatty note to the product and contribute to the oil phase of the emulsion.

In yet another embodiment of present invention, the colorant imparts whole chicken egg like color.

In yet another embodiment of present invention, the taste-enhancers of the formulation improves the taste.

In yet another embodiment of present invention, the formulation includes ingredients for imparting egg like flavor. The flavor ingredient is a natural egg flavor.

In yet another embodiment of the present invention, the components of the present formulation such as plant protein, emulsifier, edible oils, taste enhancers, salts etc. are commercially available and procured from China.

In yet another embodiment of the present invention, the present formulation is synergistic in nature and produces surprising results.

In yet another embodiment, the formulations of present invention are approximately 60 to 95% closer to the natural egg in terms of properties i.e. Leavening Properties, Emulsification, Gelation, Browning, Clarification, Taste and Mouthfeel. These are the properties important for the product to look, feel and taste like chicken egg.

In yet another embodiment, the formulations of present invention are approximately 70 to 90% closer to the natural chicken egg in terms of said properties.

In yet another embodiment, the formulations of present invention are approximately 80 to 95% closer to the natural egg in terms of said properties.

In yet another embodiment of present invention, the formulation may be used as an egg substitute in food products.

In yet another embodiment of present invention, the formulation is used for preparing a food product.

In yet another embodiment of present invention, the food product may be a baked food product, sauce, dressing, mayonnaise, custard, scramble, omelette, ice cream, pasta, burger, patty, and certain other dishes etc.

In yet another embodiment of present invention, the formulation is cost effective.

In yet another embodiment of present invention, the formulation has a shelf life of about a month or more, under refrigeration. A preferable refrigeration temperature is - 4 to 8 ° C., but not limited to this.

In yet another embodiment of present invention, the formulation is stable for at least 60 days at 40° C.

In yet another embodiment of the present invention relates to method of preparing egg liquid formulations comprising the steps of:
a. mixing of at least two plant proteins, optionally with enzyme, micro-nutrient, colorant and preservative to form a blend.
b. adding water/lentil water, emulsifier, edible oil and taste enhancer to above blend to obtain further blend.
c. adding mixture of salts to the further blend of step (b) and adjust the pH between 6.8 to 8.
d. homogenizing after step (c) under 500 to 6000 psi to reduce the particle size, followed by further processing to obtain the plant-based egg liquid formulation

In yet another embodiment of the present invention, the further processing under step (d) comprises pasteurization of the liquid to 72-85° C., followed by cooling the liquid to 4-8° C. and ageing for 24-72 hr.

In yet another embodiment of the present invention, the homogenization under step (d) is high sheer and/or two-step slow homogenization and performed for 2 to 60 mins.

In yet another embodiment of the present invention, the homogenizing is carried under 3000 to 4000 psi.

### Experimental Details

The viscosity was measured using Brookfield Ametek DVE Viscometer (spindle no. 64) at 25° C. The pH was measured using standardized pH meter (make: Arvind Industries). The sample's brix was measured using Ebro's brix meter. A two-stage homogenizer was used (make: Goma Engineering).

### General Method for Preparing the Plant-Based Egg Liquid Formulation

Mixing of at least two plant proteins, optionally with enzyme, micro-nutrient, colorant and preservative to form a blend. Adding water/lentil water, emulsifier, edible oil and taste enhancer to above blend to obtain further blend. Further, adding mixture of salts to the further blend and adjust the pH between 6.8 to 8 to obtain a liquid/mixture which is further homogenized under 500 to 6000 psi to reduce the particle size, followed by pasteurization of the liquid at 72-85° C., and cooling to 4-8° C. and ageing for 24-72 hr to obtain the plant-based egg liquid formulation.

### Lentil Water Preparation

1) Add enzyme to a solution of Mung bean protein and water (1:5)
2) Stir it thoroughly and allow it to settle down
3) Separate the supernatant by passing it through sieve and use the liquid as a water phase

The following non-limiting plant-based egg liquid formulations of the present invention are as follows:

### Example 1

Mix 20 gm mung bean protein, 29.9 gm soy protein, 13 gm chickpea protein, 10 gm pea protein, 6 gm amaranth protein, 0.0045 gm Transglutaminase, 0.2 gm turmeric, 0.15 gm potassium sorbate, 0.2 gm sodium benzoate to form a blend. 29.9 gm sunflower oil, 4.2 gm gellan gum, 5.5 gm lecithin, 10 gm tapioca syrup, 3.65 gm onion powder, 1 gm yeast extract and 352.8 gm of water were added to the blend to form further blend. The salts—0.6 gm black salt, 10 gm tricalcium phosphate, 1 gm table salt were added to further blend and pH was adjusted to 7.19 to obtain a liquid/mixture. The said liquid is homogenized at 500 psi to reduce the particle size, followed by pasteurization of the liquid at 72-85° C., and cooling to 4-8° C. and ageing for 24-72 hr to obtain the plant-based egg liquid formulation.

| | | Amount |
|---|---|---|
| Ingredients | | (wt %) |
| | Water | 70.57 |
| Proteins | mung bean | 4 |
| | soy | 5.98 |
| | chickpea | 2.6 |
| | pea | 2 |
| | amaranth | 1.2 |
| Edible oil | Sunflower oil | 5.98 |
| Emulsifier | Gellan gum | 0.84 |
| | lecithin | 1.1 |
| | tapioca syrup | 2 |
| Taste | onion powder | 0.73 |
| enhancers | yeast extract | 0.2 |
| Salts | black salt | 0.12 |
| | tricalcium | 2 |
| | phosphate | |
| | table salt | 0.2 |
| Colorants | turmeric | 0.04 |
| Preservative | potassium sorbate | 0.03 |
| | sodium benzoate | 0.4 |
| Enzyme | Transglutaminase | 0.0009 |

The Viscosity of example 1 is 960 cp and Brix is 21.2.

### Example 2

Mix 32.15 gm of mung bean protein, 15.8 gm chickpea protein, 0.005 gm Transglutaminase, 0.15 gm turmeric, 0.35 gm potassium sorbate, and 5.9 gm sodium benzoate to form a blend. 27.45 gm sunflower oil, 4.7 gm gellan gum, 1.95 gm lecithin, 10.95 gm tapioca syrup, 0.7 gm onion powder, gm yeast extract and around 392.1 gm of water were added to the blend to form further blend. The salts—0.7 gm black salt, 5.9 gm tricalcium phosphate, 0.8 gm table salt were added to further blend and pH was adjusted to 7.61 to obtain a liquid/mixture. The said liquid is homogenized at 6000 psi to reduce the particle size, followed by pasteurization of the liquid at 72-85° C., and cooling to 4-8° C. and ageing for 24-72 hours to obtain the plant-based egg liquid formulation.

| | | Amount |
|---|---|---|
| Ingredients | | (wt %) |
| | Water | 78.42 |
| Proteins | mung bean | 6.43 |
| | chickpea | 3.16 |
| Edible oil | Sunflower oil | 5.49 |
| Emulsifier | Gellan gum | 0.94 |
| | lecithin | 0.39 |
| | tapioca syrup | 2.19 |
| Taste | onion powder | 0.14 |
| enhancers | yeast extract | 0.06 |
| Salts | black salt | 0.14 |
| | tricalcium | 1.18 |
| | phosphate | |
| | table salt | 0.16 |
| Colorant | turmeric | 0.03 |
| Preservative | potassium sorbate | 0.07 |
| | sodium benzoate | 1.18 |
| Enzyme | Transglutaminase | 0.001 |

The Viscosity of example 2 is 908 cp, and Brix is 22.7.

### Example 3

Mix 53.15 gm of mung bean protein, 10.65 gm of soy protein, 2.15 gm chickpea protein, 0.01 gm Transglutaminase, 1.05 gm of BCAA, 0.1 gm turmeric, 1.3 gm potassium sorbate, and 9.05 gm sodium benzoate to form a blend. 21.25 gm sunflower oil, 3.2 gm gellan gum, 11.7 gm lecithin, 10.65 gm tapioca syrup, 3.9 gm onion powder, 1.05 gm yeast extract and around 360 gm of water were added to the blend to form further blend. The salts—0.65 gm black salt, 9.05 gm tricalcium phosphate, 1.05 gm table salt were added to further blend and pH was adjusted to 7.02 to obtain a liquid/mixture. The said liquid is homogenized at 4000 psi to reduce the particle size, followed by pasteurization of the liquid at 72-85° C., and cooling to 4-8° C. and ageing for 24-72 hours to obtain the plant-based egg liquid formulation.

| | | Amount |
|---|---|---|
| Ingredients | | (wt %) |
| | Water | 72 |
| Proteins | mung bean | 10.63 |
| | soy | 2.13 |
| | chickpea | 0.43 |
| Edible oil | Sunflower oil | 4.25 |
| Emulsifier | Gellan gum | 0.64 |
| | lecithin | 2.34 |
| | tapioca syrup | 2.13 |
| Taste enhancers | onion powder | 0.78 |
| | yeast extract | 0.21 |
| Salts | black salt | 0.13 |
| | tricalcium | 1.81 |
| | phosphate | |
| | table salt | 0.21 |
| Colorant | turmeric | 0.02 |
| Preservative | potassium | 0.26 |
| | sorbate | |
| | sodium benzoate | 1.81 |
| Enzyme | Transglutaminase | 0.002 |
| Micro-nutrients | BCAA (gm) | 0.21 |

The Viscosity of Example 3 is 1200 cp; and Brix is 24.1.

### Example 4

Mix 23.7 gm of soy protein, 0.5 gm of pea protein, and 0.05 gm of turmeric to form a blend. 43.4 gm of sunflower oil, 2.15 gm of xanthan, 3.65 gm of gellan gum, 1.75 gm of lecithin, 0.45 gm of yeast extract, 0.45 gm of vegan egg flavour, and around 419.1 gm of lentil water were added to the blend to form further blend. The salts—0.5 gm of black salt, and 4.8 gm of tricalcium phosphate were added to further blend and pH was adjusted to 7.55 to obtain a liquid/mixture. The said liquid is homogenized at 1000 psi to reduce the particle size, followed by pasteurization of the liquid at 72-85° C., and cooling to 4-8° C. and ageing for 24-72 hours to obtain the plant-based egg liquid formulation.

| | | Amount |
|---|---|---|
| Ingredients | | (wt %) |
| | Lentil water | 83.82 |
| Proteins | soy | 4.74 |
| | pea | 0.1 |
| Edible oil | Sunflower oil | 8.68 |
| Emulsifier | Xanthan gum | 0.43 |
| | Gellan gum | 0.73 |
| | lecithin | 0.35 |
| Taste | yeast extract | 0.09 |
| enhancers | vegan egg | 0.09 |
| | flavour | |
| Salts | black salt | 0.1 |
| | tricalcium | 0.96 |
| | phosphate | |
| Colorant | turmeric | 0.01 |

The Viscosity of Example 4 is 162 cp; and Brix is 21.5.

### Example 5

Mix 22.7 gm of mung bean protein, 30.3 gm of soy protein, 18.95 gm of chickpea protein, 18.95 gm of pea protein, 0.0038 gm of Transglutaminase, 0.185 gm of sodium benzoate, and 0.45 gm of calcium propionate to form a blend. 11.35 gm of sunflower oil, 15.15 gm of peanut, 7.55 gm of soy, 7.55 gm of cannola, 7.55 gm of ricebran, 1.1 gm of mustard, 0.0379 gm of xanthan, 0.985 gm of gellan gum, 0.0379 gm of loctus bean gum, 0.65 gm of lecithin, 0.375 gm of onion powder, 2.25 gm of sugar, 0.95 gm of yeast extract, 1.365 gm of vegan egg flavour, and around 346.85 gm of water were added to the blend to form further blend. The salts—1.7 gm of black salt, 0.985 gm of tetra sodium pyrophosphate, 1.7 gm of potassium citrate, and 0.3 gm of table salt were added to further blend and pH was adjusted to 6.9 to obtain a liquid/mixture. The said liquid is homogenized at 4500 psi to reduce the particle size, followed by pasteurization of the liquid at 72-85° C., and cooling to 4-8° C. and ageing for 24-72 hours to obtain the plant-based egg liquid formulation.

| | | Amount |
|---|---|---|
| Ingredients | | (wt %) |
| | water | 69.37 |
| Proteins | Mung bean | 4.54 |
| | Soy | 6.06 |
| | Chickpea | 3.79 |
| | pea | 3.79 |
| Edible oil | Sunflower oil | 2.27 |
| | Peanut oil | 3.03 |
| | Soy oil | 1.51 |
| | Cannola oil | 1.51 |
| | Ricebran oil | 1.51 |
| | Mustard oil | 0.22 |
| Emulsifier | Xanthan gum | 0.00758 |
| | Gellan gum | 0.197 |
| | loctus bean gum | 0.00758 |
| | tamarid gum | 0.00758 |
| | lecithin | 0.13 |
| Taste | yeast extract | 0.19 |
| enhancers | Onion powder | 0.075 |
| | Sugar | 0.45 |
| | vegan egg flavour | 0.273 |
| Salts | black salt | 0.34 |
| | tetra sodium | 0.197 |
| | pyrophosphate | |
| | potassium citrate | 0.34 |
| | Table salt | 0.06 |
| Preservative | sodium benzoate | 0.037 |
| | calcium | 0.09 |
| | propionate | |
| Enzymes | Transglutaminase | 0.00076 |

The Viscosity of Example 5 is 780 cp; and Brix is 23.6.

### Example 6

Mix 63.7 gm of mung bean protein, 7.325 gm of soy protein, 7.325 gm of pea protein, 0.0029 gm of Transglutaminase, 1.465 gm of curcumin, 1.465 gm of turmeric, 0.365 gm of potassium sorbate, and 0.145 gm of sodium benzoate to form a blend. 45.35 gm of sunflower oil, 16.0 gm of cannola, 2.95 gm of ricebran, 0.035 gm of xanthan, 0.435 gm of gellan gum, 0.035 gm of loctus bean gum, gm of tamarind gum, 0.585 gm of lecithin, 0.325 gm of tapioca syrup, 0.45 gm of onion powder, 0.215 gm of garlic powder, 1.975 gm of sugar, 0.805 gm of yeast extract, 1.35 gm of vegan egg flavour, and around 343.25 gm of water were added to the blend to form further blend. The salts—0.915 gm of black salt, 0.95 gm of tetra sodium pyrophosphate, 1.465 gm of potassium citrate, and 1.095 gm of table salt were added to further blend and pH was adjusted to 7.89 to obtain a liquid/mixture. The said liquid is homogenized at 2000 psi to reduce the particle size, followed by pasteurization of the liquid at 72-85° C., and cooling to 4-8° C. and ageing for 24-72 hours to obtain the plant-based egg liquid formulation.

| | | Amount |
|---|---|---|
| Ingredients | | (wt %) |
| | water | 68.65 |
| Proteins | Mung bean | 12.74 |
| | Soy | 1.465 |
| | pea | 1.465 |
| Edible oil | Sunflower oil | 9.07 |
| | Cannola oil | 3.2 |
| | Ricebran oil | 0.59 |
| Emulsifier | Xanthan gum | 0.007 |
| | Gellan gum | 0.087 |
| | loctus bean gum | 0.007 |
| | tamarid gum | 0.007 |
| | lecithin | 0.117 |
| | tapioca syrup | 0.065 |
| Taste | yeast extract | 0.161 |
| enhancers | Onion powder | 0.09 |
| | Garlic powder | 0.043 |
| | Sugar | 0.395 |
| | vegan egg flavour | 0.27 |
| Salts | black salt | 0.183 |
| | tetra sodium | 0.19 |
| | pyrophosphate | |
| | potassium citrate | 0.293 |
| | Table salt | 0.219 |
| Colorant | curcumin | 0.293 |
| | turmeric | 0.293 |
| Preservative | potassium | 0.073 |
| | sorbate | |
| | sodium benzoate | 0.029 |
| Enzymes | Transglutaminase | 0.00058 |

The Viscosity of Example 6 is 684 cp; and Brix is 17.4.

Similarly, further formulations of Examples 7 to 15 are prepared in accordance with the general method detailed above. The pH of the liquid formulation and the homogenization pressure is mentioned at the end of each table below.

### Example 7

| | | Amount |
|---|---|---|
| Ingredients | | (wt %) |
| | Water | 71.39 |
| Proteins | mung bean | 15.27 |
| | soy | 1.17 |
| | chickpea | 0.73 |
| | pea | 0.73 |
| Edible oil | Sunflower oil | 2.05 |
| | Peanut oil | 1.76 |
| | Soy oil | 2.49 |
| | Cannola oil | 0.29 |
| | Ricebran oil | 2.34 |
| Emulsifier | Gellan gum | 0.16 |
| | lecithin | 0.11 |
| | tapioca syrup | 0.06 |
| Taste | onion powder | 0.066 |
| enhancers | sugar | 0.396 |
| | yeast extract | 0.16 |
| Salts | black salt | 0.26 |
| | tetra sodium | 0.16 |
| | pyrophosphate | |
| | potassium citrate | 0.29 |
| | table salt | 0.36 |
| Colorant | curcumin | 0.02 |
| | turmeric | 0.02 |
| Preservative | potassium sorbate | 0.07 |
| | sodium benzoate | 0.036 |
| Enzyme | Transglutaminase | 0.000587 |

The Viscosity of Example 7 is 756 cp, pH is 7.7, Brix is 21.6, and homogenization pressure (psi) is 5000.

### Example 8

| | | Amount |
|---|---|---|
| Ingredients | | (wt %) |
| | Water | 68.07 |
| Proteins | mung bean | 14.83 |
| | soy | 2.85 |
| | chickpea | 1.43 |
| | pea | 1.14 |
| Edible oil | Sunflower oil | 3.3 |
| | Cannola oil | 3.3 |
| | Ricebran oil | 3.3 |
| Emulsifier | Gellan gum | 0.157 |
| | lecithin | 0.114 |
| | tapioca syrup | 0.064 |
| Taste | onion powder | 0.06 |
| enhancers | sugar | 0.385 |
| | yeast extract | 0.16 |
| Salts | black salt | 0.257 |
| | tetra sodium | 0.157 |
| | pyrophosphate | |
| | potassium citrate | 0.285 |
| | table salt | 0.357 |
| Colorant | curcumin | 0.029 |
| | turmeric | 0.029 |
| Preservative | potassium sorbate | 0.07 |
| | sodium benzoate | 0.036 |
| Enzyme | Transglutaminase | 0.000855 |

The Viscosity of Example 8 is 680 cp, pH is 6.8, Brix is 20.1, and homogenization pressure (psi) is 2500.

### Example 9

| | | Amount |
|---|---|---|
| Ingredients | | (wt %) |
| | Water | 59.45 |
| Proteins | mung bean | 20.28 |
| | soy | 0.734 |
| | chickpea | 1.76 |
| | pea | 6.61 |
| Edible oil | Sunflower oil | 9.09 |
| Emulsifier | Gellan gum | 0.089 |
| | lecithin | 0.117 |
| Taste | onion powder | 0.066 |
| enhancers | sugar | 0.4 |
| | yeast extract | 0.162 |
| Salts | black salt | 0.264 |
| | tetra sodium | 0.1616 |
| | pyrophosphate | |
| | potassium citrate | 0.29 |
| | table salt | 0.367 |
| Colorant | curcumin | 0.029 |
| | turmeric | 0.029 |
| Preservative | potassium sorbate | 0.073 |
| | sodium benzoate | 0.0367 |
| Enzyme | Transglutaminase | 0.000587 |

The Viscosity of Example 9 is 820 cp, pH is 6.92, Brix is 23.2, and homogenization pressure (psi) is 1500.

### Example 10

| | | Amount |
|---|---|---|
| Ingredients | | (wt %) |
| | Water | 73.58 |
| Proteins | mung bean | 12.115 |
| | soy | 2.42 |
| | pea | 0.05 |
| Edible oil | Sunflower oil | 9.035 |
| Emulsifier | Gellan gum | 0.087 |
| | lecithin | 0.117 |
| | tapioca syrup | 0.066 |
| Taste | onion powder | 0.9 |
| enhancers | garlic powder | 0.044 |
| | sugar | 0.394 |
| Salts | black salt | 0.263 |
| | tetra sodium | 0.16 |
| | pyrophosphate | |
| | potassium citrate | 0.292 |
| | table salt | 0.365 |
| Colorant | curcumin | 0.029 |
| | turmeric | 0.029 |
| Preservative | potassium sorbate | 0.073 |
| | sodium benzoate | 0.0365 |
| Enzyme | Transglutaminase | 0.00088 |

The Viscosity of Example 10 is 352 cp, pH is 7.1, Brix is 18.5, and homogenization pressure (psi) is 3000.

### Example 11

| | | Amount |
|---|---|---|
| Ingredients | | (wt %) |
| | Water | 57.78 |
| Proteins | mung bean | 11.54 |
| | soy | 7.24 |
| | chickpea | 2.1 |
| | fawa bean | 2.42 |
| | bengal gram | 0.27 |
| | amaranth | 1.84 |
| Edible oil | Cannola oil | 15 |
| Emulsifier | Gellan gum | 0.088 |
| | lecithin | 0.117 |
| | tapioca syrup | 0.066 |
| Taste | onion powder | 0.09 |
| enhancers | garlic powder | 0.044 |
| | sugar | 0.396 |
| | yeast extract | 0.16 |
| Salts | black salt | 0.183 |
| | potassium citrate | 0.29 |
| | table salt | 0.22 |
| Colorant | curcumin | 0.029 |
| | turmeric | 0.029 |
| Preservative | potassium sorbate | 0.073 |
| | sodium benzoate | 0.029 |
| Enzyme | Transglutaminase | 0.00059 |

The Viscosity of Example 11 is 587 cp, pH is 7.2, Brix is 21.9, and homogenization pressure (psi) is 2500.

### Example 12

| | | Amount |
|---|---|---|
| Ingredients | | (wt %) |
| | Water | 54.7 |
| Proteins | mung bean | 15 |
| | soy | 1.45 |
| | chickpea | 2.67 |
| | amaranth | 1.63 |
| Edible oil | Sunflower oil | 10 |
| | Peanut oil | 0.5 |
| | Soy oil | 10 |
| | palm oil | 0.31 |
| | Ricebran oil | 1.63 |
| | Mustard oil | 0.025 |
| Emulsifier | Gellan gum | 0.095 |
| | lecithin | 0.14 |
| | tapioca syrup | 0.066 |
| Taste | onion powder | 0.085 |
| enhancers | garlic powder | 0.039 |
| | sugar | 0.4 |
| | yeast extract | 0.15 |
| Salts | black salt | 0.19 |
| | tetra sodium | 0.16 |
| | pyrophosphate | |
| | potassium citrate | 0.3 |
| | table salt | 0.3 |
| Colorant | curcumin | 0.029 |
| | turmeric | 0.029 |
| Preservative | potassium sorbate | 0.073 |
| | sodium benzoate | 0.03 |
| Enzyme | Transglutaminase | 0.00035 |

The Viscosity of Example 12 is 482 cp, pH is 7.6, Brix is 19.6, and homogenization pressure (psi) is 3500.

### Example 13

| | | Amount |
|---|---|---|
| Ingredients | | (wt %) |
| | Water | 60.35 |
| Proteins | mung bean | 12 |
| | soy | 0.5 |
| | pea | 0.1 |
| Edible oil | Sunflower oil | 10 |
| | Cannola oil | 10 |
| | Ricebran oil | 5 |
| Emulsifier | Gellan gum | 0.022 |
| | methyl cellulose | 0.042 |
| | lecithin | 0.12 |
| | tapioca syrup | 0.066 |
| Taste | onion powder | 0.078 |
| enhancers | garlic powder | 0.035 |
| | sugar | 0.43 |
| | yeast extract | 0.06 |
| | vegan egg flavour | 0.08 |
| Salts | black salt | 0.35 |
| | tetra sodium | 0.14 |
| | pyrophosphate | |
| | potassium citrate | 0.33 |
| | table salt | 0.24 |
| Colorant | curcumin | 0.029 |
| | turmeric | 0.029 |
| Preservative | potassium sorbate | 0.073 |
| | sodium benzoate | 0.031 |
| Enzyme | Transglutaminase | 0.0028 |

The Viscosity of Example 13 is 741 cp, pH is 7.4, Brix is 22.8, and homogenization pressure (psi) is 2500.

### Example 14

| | | Amount |
|---|---|---|
| Ingredients | | (wt %) |
| | Water | 80.09 |
| Proteins | mung bean | 7 |
| | soy | 0.2 |
| | chickpea | 0.42 |
| Edible oil | Sunflower oil | 7.85 |
| | Cannola oil | 2.27 |
| Emulsifier | Guar gum | 0.05 |
| | Gellan gum | 0.07 |
| | Acacia gum | 0.1 |
| | lecithin | 0.165 |
| | tapioca syrup | 0.066 |
| Taste | onion powder | 0.057 |
| enhancers | garlic powder | 0.051 |
| | sugar | 0.37 |
| | yeast extract | 0.012 |
| Salts | black salt | 0.14 |
| | pink salt | 0.12 |
| | tetra sodium | 0.13 |
| | pyrophosphate | |
| | potassium citrate | 0.28 |
| | table salt | 0.323 |
| Colorant | curcumin | 0.029 |
| | turmeric | 0.029 |
| Preservative | potassium sorbate | 0.073 |
| | sodium benzoate | 0.27 |
| | calcium propionate | 0.04 |
| Enzyme | Transglutaminase | 0.00043 |

The Viscosity of Example 14 is 697 cp, pH is 6.9, Brix is 23.7, and homogenization pressure (psi) is 3000.

### Example 15

| | | Amount |
|---|---|---|
| Ingredients | | (wt %) |
| | Water | 75.5 |
| Proteins | mung bean | 13 |
| | pea | 0.34 |
| Edible oil | Sunflower oil | 8.9 |
| Emulsifier | Gellan gum | 0.101 |
| | tapioca syrup | 0.06 |
| Taste | onion powder | 0.115 |
| enhancers | garlic powder | 0.02 |
| | sugar | 0.38 |
| | yeast extract | 0.185 |
| Salts | black salt | 0.1 |
| | tetra sodium | 1.34 |
| | pyrophosphate | |
| | potassium citrate | 0.198 |
| | tricalcium phosphate | 0.19 |
| | table salt | 0.178 |
| Preservative | potassium sorbate | 0.318 |
| | sodium benzoate | 0.044 |
| Micro- | Vitamin A (mcg) | 270 |
| nutrients | Vitamin B1 (mcg) | 400 |
| | Vitamin B2 (mcg) | 0.8 |
| | Vitamin B12 (mcg) | 1.6 |
| | Vitamin D (IU) | 1 |
| | BCAA (gm) | 0.382 |

The Viscosity of Example 15 is 172 cp, pH is 7.9, Brix is 23.5, and homogenization pressure (psi) is 3500.

### Stability Data

An accelerated stability test was conducted at 40° C. for a period of 60 days. The samples were accessed for chemical (acidity, ash, viscosity, pH) and microbial degradation (total plate count (TPC), E coli count, Coliform count).

STABILITY DATA AT 40 C. AND 75Rh (Example 3)

| | MOISTURE | ASH | ACIDITY | | VISCOSITY | | MICROBIAL PER G | | |
|---|---|---|---|---|---|---|---|---|---|
| DAYS | % | % | % | pH | (cp) | GELATION | TPC | E COLI | COLIFORM |
| 1 | 75.00 | 0.34 | 0.3 | 7.5 | 162 | 7 MIN | | | |
| 2 | 76.00 | 0.32 | 0.3 | 7.5 | 162 | 8 MIN | | | |
| 3 | 75.00 | 0.33 | 0.3 | 7.5 | 175 | 6 MIN | 5*10³ | ABSENT | NIL |
| 4 | 75.33 | 0.32 | 0.21 | 7.5 | 176 | 6 MIN | | | |
| 5 | 75.33 | 0.315 | 0.215 | 7.5 | 175 | 6 MIN | | | |
| 6 | 75.33 | 0.31 | 0.214 | 7.5 | 181 | 6 MIN | | | |
| 7 | 75.33 | 0.305 | 0.213 | 7.5 | 175 | 6 MIN | 8*10³ | ABSENT | NIL |
| 8 | 75.33 | 0.3 | 0.212 | 7.5 | 185 | 6 MIN | 2*10⁴ | ABSENT | NIL |
| 9 | 75.33 | 0.295 | 0.211 | 7.5 | 210 | 6 MIN | | | |
| 10 | 75.33 | 0.29 | 0.21 | 7.5 | 211 | 6 MIN | 8*10⁴ | ABSENT | NIL |
| 11 | 75.33 | 0.285 | 0.209 | 7.45 | 210 | 6 MIN | | | |
| 12 | 75.33 | 0.34 | 0.208 | 7.45 | 240 | 6 MIN | | | |
| 13 | 75.33 | 0.32 | 0.207 | 7.45 | 255 | 6 MIN | 4*10⁴ | ABSENT | NIL |
| 14 | 75.33 | 0.33 | 0.206 | 7.45 | 270 | 6 MIN | 5*10⁴ | ABSENT | NIL |
| 15 | 75.33 | 0.32 | 0.205 | 7.45 | 285 | 5 MIN | | | |
| 16 | 75.33 | 0.34 | 0.204 | 7.45 | 300 | 6 MIN | 9*10⁴ | ABSENT | NIL |
| 17 | 75.33 | 0.32 | 0.203 | 7.45 | 315 | 6 MIN | 2*10⁴ | ABSENT | NIL |
| 18 | 75.33 | 0.33 | 0.202 | 7.5 | 330 | 6 MIN | | | |
| 19 | 75.33 | 0.32 | 0.201 | 7.5 | 345 | 6 MIN | 10*10⁴ | ABSENT | NIL |
| 20 | 75.33 | 0.315 | 0.2 | 7.5 | 360 | 6 MIN | | | |
| 21 | 75.33 | 0.31 | 0.199 | 7.5 | 375 | 6 MIN | | | |
| 22 | 75.33 | 0.305 | 0.198 | 7.5 | 390 | 6 MIN | 10*10⁴ | ABSENT | NIL |
| 23 | 75.33 | 0.34 | 0.197 | 7.45 | 405 | 6 MIN | 1*10⁵ | ABSENT | NIL |
| 24 | 75.33 | 0.32 | 0.196 | 7.45 | 420 | 6 MIN | | | |
| 25 | 75.33 | 0.33 | 0.195 | 7.45 | 435 | 6 MIN | | | |
| 26 | 75.33 | 0.32 | 0.194 | 7.45 | 450 | 6 MIN | | | |
| 27 | 75.33 | 0.315 | 0.193 | 7.45 | 465 | 6 MIN | | | |
| 28 | 75.33 | 0.34 | 0.192 | 7.5 | 480 | 6 MIN | | | |
| 29 | 75.33 | 0.32 | 0.191 | 7.5 | 495 | 6 MIN | | | |
| 30 | 75.33 | 0.33 | 0.19 | 7.45 | 510 | 6 MIN | 9*10⁴ | ABSENT | NIL |
| 31 | 75.33 | 0.32 | 0.189 | 7.45 | 525 | 6 MIN | | | |
| 32 | 75.33 | 0.315 | 0.188 | 7.45 | 540 | 6 MIN | | | |
| 33 | 75.33 | 0.31 | 0.187 | 7.45 | 555 | 6 MIN | | | |
| 34 | 75.33 | 0.34 | 0.186 | 7.45 | 570 | 6 MIN | | | |
| 35 | 75.33 | 0.32 | 0.185 | 7.5 | 585 | 6 MIN | | | |
| 36 | 75.33 | 0.33 | 0.184 | 7.5 | 600 | 6 MIN | | | |
| 37 | 75.33 | 0.32 | 0.183 | 7.45 | 615 | 6 MIN | | | |
| 38 | 75.33 | 0.32 | 0.182 | 7.45 | 630 | 6 MIN | | | |
| 39 | 75.33 | 0.315 | 0.181 | 7.45 | 645 | 6 MIN | | | |
| 40 | 75.33 | 0.31 | 0.18 | 7.45 | 660 | 6 MIN | | | |
| 41 | 75.33 | 0.34 | 0.179 | 7.45 | 675 | 6 MIN | 2*10⁴ | ABSENT | NIL |
| 42 | 75.33 | 0.32 | 0.178 | 7.5 | 690 | 6 MIN | | | |
| 43 | 75.33 | 0.33 | 0.177 | 7.5 | 705 | 6 MIN | | | |
| 44 | 75.33 | 0.32 | 0.176 | 7.45 | 720 | 6 MIN | | | |
| 45 | 75.33 | 0.32 | 0.175 | 7.45 | 735 | 6 MIN | | | |
| 46 | 75.33 | 0.315 | 0.174 | 7.45 | 750 | 6 MIN | 7*10⁵ | ABSENT | NIL |
| 47 | 75.33 | 0.31 | 0.173 | 7.45 | 765 | 6 MIN | | | |
| 48 | 75.33 | 0.34 | 0.172 | 7.45 | 780 | 6 MIN | | | |
| 49 | 75.33 | 0.32 | 0.171 | 7.5 | 795 | 6 MIN | | | |
| 50 | 75.33 | 0.33 | 0.17 | 7.5 | 810 | 6 MIN | | | |
| 51 | 75.33 | 0.32 | 0.169 | 7.45 | 825 | 6 MIN | | | |
| 52 | 75.33 | 0.32 | 0.168 | 7.45 | 840 | 6 MIN | 8*10⁴ | ABSENT | NIL |
| 53 | 75.33 | 0.32 | 0.167 | 7.45 | 855 | 6 MIN | | | |
| 54 | 75.33 | 0.32 | 0.166 | 7.5 | 870 | 6 MIN | | | |
| 55 | 75.33 | 0.315 | 0.165 | 7.5 | 885 | 6 MIN | | | |
| 56 | 75.33 | 0.31 | 0.164 | 7.45 | 900 | 6 MIN | 2*10⁴ | ABSENT | NIL |
| 57 | 75.33 | 0.34 | 0.163 | 7.45 | 915 | 6 MIN | | | |
| 58 | 75.33 | 0.32 | 0.162 | 7.45 | 930 | 6 MIN | | | |
| 59 | 75.33 | 0.33 | 0.161 | 7.45 | 945 | 6 MIN | | | |
| 60 | 75.33 | 0.32 | 0.16 | 7.45 | 960 | 6 MIN | 9*10⁴ | ABSENT | NIL |

STABILITY DATA AT 40 C. AND 75Rh (Example 15)

| | MOISTURE | ASH | ACIDITY | | VISCOSITY | | MICROBIAL PER G | | |
|---|---|---|---|---|---|---|---|---|---|
| DAYS | % | % | % | pH | CP | GELATION | TPC | E COLI | COLIFORM |
| 1 | 75.00 | 0.34 | 0.3 | 7.9 | 172 | 7 MIN | | | |
| 2 | 76.00 | 0.32 | 0.3 | 7.9 | 172 | 8 MIN | | | |
| 3 | 75.00 | 0.33 | 0.3 | 7.8 | 175 | 6 MIN | 5*10³ | ABSENT | NIL |
| 4 | 75.33 | 0.32 | 0.21 | 7.5 | 176 | 6 MIN | | | |
| 5 | 75.33 | 0.315 | 0.215 | 7.5 | 177.5 | 6 MIN | | | |
| 6 | 75.33 | 0.31 | 0.214 | 7.5 | 179 | 6 MIN | | | |
| 7 | 75.33 | 0.305 | 0.213 | 7.5 | 180.5 | 6 MIN | 6*10³ | ABSENT | NIL |
| 8 | 75.33 | 0.3 | 0.212 | 7.5 | 182 | 6 MIN | 10*10⁴ | ABSENT | NIL |
| 9 | 75.33 | 0.295 | 0.211 | 7.5 | 183.5 | 6 MIN | | | |
| 10 | 75.33 | 0.29 | 0.21 | 7.5 | 185 | 6 MIN | 8*10⁴ | ABSENT | NIL |
| 11 | 75.33 | 0.285 | 0.209 | 7.45 | 186.5 | 6 MIN | | | |
| 12 | 75.33 | 0.34 | 0.208 | 7.45 | 188 | 6 MIN | | | |
| 13 | 75.33 | 0.32 | 0.207 | 7.45 | 189.5 | 6 MIN | 9*10⁴ | ABSENT | NIL |
| 14 | 75.33 | 0.33 | 0.206 | 7.45 | 191 | 6 MIN | 2*10⁴ | ABSENT | NIL |
| 15 | 75.33 | 0.32 | 0.205 | 7.45 | 192.5 | 5 MIN | | | |
| 16 | 75.33 | 0.34 | 0.204 | 7.45 | 194 | 6 MIN | 7*10⁴ | ABSENT | NIL |
| 17 | 75.33 | 0.32 | 0.203 | 7.45 | 195.5 | 6 MIN | 7*10⁴ | ABSENT | NIL |
| 18 | 75.33 | 0.33 | 0.202 | 7.5 | 197 | 6 MIN | | | |
| 19 | 75.33 | 0.32 | 0.201 | 7.5 | 198.5 | 6 MIN | 10*10⁴ | ABSENT | NIL |
| 20 | 75.33 | 0.315 | 0.2 | 7.5 | 200 | 6 MIN | | | |
| 21 | 75.33 | 0.31 | 0.199 | 7.5 | 201.5 | 6 MIN | | | |
| 22 | 75.33 | 0.305 | 0.198 | 7.5 | 203 | 6 MIN | 10*10⁴ | ABSENT | NIL |
| 23 | 75.33 | 0.34 | 0.197 | 7.45 | 204.5 | 6 MIN | 1*10⁵ | ABSENT | NIL |
| 24 | 75.33 | 0.32 | 0.196 | 7.45 | 206 | 6 MIN | | | |
| 25 | 75.33 | 0.33 | 0.195 | 7.45 | 207.5 | 6 MIN | | | |
| 26 | 75.33 | 0.32 | 0.194 | 7.45 | 209 | 6 MIN | | | |
| 27 | 75.33 | 0.315 | 0.193 | 7.45 | 210.5 | 6 MIN | | | |
| 28 | 75.33 | 0.34 | 0.192 | 7.5 | 212 | 6 MIN | | | |
| 29 | 75.33 | 0.32 | 0.191 | 7.5 | 213.5 | 6 MIN | | | |
| 30 | 75.33 | 0.33 | 0.19 | 7.45 | 215 | 6 MIN | 9*10⁴ | ABSENT | NIL |
| 31 | 75.33 | 0.32 | 0.189 | 7.45 | 216.5 | 6 MIN | | | |
| 32 | 75.33 | 0.315 | 0.188 | 7.45 | 218 | 6 MIN | | | |
| 33 | 75.33 | 0.31 | 0.187 | 7.45 | 219.5 | 6 MIN | | | |
| 34 | 75.33 | 0.34 | 0.186 | 7.45 | 221 | 6 MIN | | | |
| 35 | 75.33 | 0.32 | 0.185 | 7.5 | 222.5 | 6 MIN | | | |
| 36 | 75.33 | 0.33 | 0.184 | 7.5 | 224 | 6 MIN | | | |
| 37 | 75.33 | 0.32 | 0.183 | 7.45 | 225.5 | 6 MIN | | | |
| 38 | 75.33 | 0.32 | 0.182 | 7.45 | 227 | 6 MIN | | | |
| 39 | 75.33 | 0.315 | 0.181 | 7.45 | 228.5 | 6 MIN | | | |
| 40 | 75.33 | 0.31 | 0.18 | 7.45 | 230 | 6 MIN | | | |
| 41 | 75.33 | 0.34 | 0.179 | 7.45 | 231.5 | 6 MIN | 2*10⁴ | ABSENT | NIL |
| 42 | 75.33 | 0.32 | 0.178 | 7.5 | 233 | 6 MIN | | | |
| 43 | 75.33 | 0.33 | 0.177 | 7.5 | 234.5 | 6 MIN | | | |
| 44 | 75.33 | 0.32 | 0.176 | 7.45 | 236 | 6 MIN | | | |
| 45 | 75.33 | 0.32 | 0.175 | 7.45 | 237.5 | 6 MIN | | | |
| 46 | 75.33 | 0.315 | 0.174 | 7.45 | 239 | 6 MIN | 6*10⁴ | ABSENT | NIL |
| 47 | 75.33 | 0.31 | 0.173 | 7.45 | 240.5 | 6 MIN | | | |
| 48 | 75.33 | 0.34 | 0.172 | 7.45 | 242 | 6 MIN | | | |
| 49 | 75.33 | 0.32 | 0.171 | 7.5 | 243.5 | 6 MIN | | | |
| 50 | 75.33 | 0.33 | 0.17 | 7.5 | 245 | 6 MIN | | | |
| 51 | 75.33 | 0.32 | 0.169 | 7.45 | 246.5 | 6 MIN | | | |
| 52 | 75.33 | 0.32 | 0.168 | 7.45 | 248 | 6 MIN | 3*10⁴ | ABSENT | NIL |
| 53 | 75.33 | 0.32 | 0.167 | 7.45 | 249.5 | 6 MIN | | | |
| 54 | 75.33 | 0.32 | 0.166 | 7.5 | 251 | 6 MIN | | | |
| 55 | 75.33 | 0.315 | 0.165 | 7.5 | 252.5 | 6 MIN | | | |
| 56 | 75.33 | 0.31 | 0.164 | 7.45 | 254 | 6 MIN | 1*10⁵ | ABSENT | NIL |
| 57 | 75.33 | 0.34 | 0.163 | 7.45 | 255.5 | 6 MIN | | | |
| 58 | 75.33 | 0.32 | 0.162 | 7.45 | 257 | 6 MIN | | | |
| 59 | 75.33 | 0.33 | 0.161 | 7.45 | 258.5 | 6 MIN | | | |
| 60 | 75.33 | 0.32 | 0.16 | 7.45 | 260 | 6 MIN | 7*10⁵ | ABSENT | NIL |

The plant-based egg liquid formulations of examples 3 and 15 were found stable. These formulations have stability for at least 60 days at 40° C. Undesirable changes in organoleptic properties (taste and smell) were observed thereafter, following which the stability study was terminated.

The plant-based egg liquid formulations of the present invention are very cost effective from consumer point of view. Also, it provides additional nutrients/micro-nutrients for supplementing the diet. Further, the egg formulations of the present invention are found to be safe and can be well preserved for sufficiently long time.

1. A plant-based egg liquid formulation comprising,
at least two plant proteins in the range of 4 to 30% selected from mung bean protein, soy protein, chickpea protein, pea proteins (yellow pea, green peas), fawa bean, bengal gram, black gram, amaranth protein, mushroom or combinations thereof,
edible oil in the range of 3 to 25% selected from peanut oil, palm oil, soya oil, rice bran oil, sunflower oil, mustard oil, canola oil or combination thereof;
emulsifiers in the range of 0.1% to 3% selected from xanthan gum, guar gum, gellan gum, acacia gum, methyl cellulose, tapioca syrup, lecithin, soy lecithin, Locust Bean Gum, tamarind gum, modified starch, or combination thereof;
salts in the range of 0.1% to 3% selected from a mixture of pink salt, black salt, table salt, tricalcium phosphate, tetra sodium pyrophosphate, potassium citrate;
taste enhancers in the range of 0.05% to 2% selected from vegan nutritional yeast extract, vegan egg flavor, sugar, dried powder or pastes of onion, garlic, or combination thereof.

2. The plant-based egg liquid formulation as claimed in claim 1, further comprising flavors, micro-nutrients, enzyme, colorant and preservatives.

3. The plant-based egg liquid formulation as claimed in claim 1, wherein the plant proteins is preferably in the form of an isolate, concentrate, hydroisolate and/or peptides.

4. The plant-based egg liquid formulation as claimed in claim 2, wherein the colorant is selected from turmeric, curcumin, and any other natural or food colorant or combination thereof.

5. The plant-based egg liquid formulation as claimed in claim 2, wherein the preservative is selected from potassium sorbate, sodium benzoate, calcium propionate or combination thereof.

6. The plant-based egg liquid formulation as claimed in claim 2, wherein the micro-nutrients are selected from Vitamin A, Vitamin E, Vitamin C, Vitamin D, Vitamin K, Vitamin B1, Vitamin B12, Vitamin B6, BCAA (branch-chain amino acids) or combination thereof.

7. The plant-based egg liquid formulation as claimed in any one of claims 1 to 6, wherein the said formulation comprising:
at least two plant proteins selected from mung bean protein, chickpea protein, soy protein, pea protein in the range of 10-25%;
edible oils selected from sunflower oil, rice bran oil, canola oil or combination thereof in the range of 5-20%;
emulsifiers selected from gellan gum, tapioca syrup, lecithin or combination thereof in the range of 0.2-2%;
salts selected from the mixture of black salt, pink salt, table salt, tricalcium phosphate, tetra sodium pyrophosphate, potassium citrate in the range of 0.1-2%
taste enhancers selected from onion powder, garlic powder, vegan egg flavour, sugar, vegan nutritional yeast extract or combination thereof in the range of 0.01-0.3% colorant selected from curcumin, turmeric or combination thereof in the range of 0.01-0.06%
preservatives selected from potassium sorbate, sodium benzoate, calcium propionate or combination thereof in the range of 0.01-2%; and
transglutaminase as an enzyme in the range of 0.0003-0.003%.

8. The plant-based egg liquid formulation as claimed in any one of claims 1 to 7, wherein the said formulation comprising: mung bean protein about 13%; pea protein about 0.34%; sunflower oil about 8.90%; gellan gum about 0.101%, tapioca syrup about 0.06%; table salt about 0.178%, black salt about 0.1%, sugar about 0.38%, onion powder about 0.115, garlic powder about 0.02%, potassium sorbate 0.318%, sodium benzoate about 0.044%, tetra sodium pyrophosphate about 1.34%, yeast extract about 0.185%; water 75.5%; vitamin A about 270 mcg, vitamin B1 about 400 mcg, vitamin B2 about 0.8 mcg, vitamin B12 about vitamin D about 1 IU and branched chain amino acid about 0.382 mg.

9. The plant-based egg liquid formulation as claimed in any one of claims 1 to 7, wherein the said formulation comprising: mung bean protein about 10.63%; soy protein about 2.13%, chickpea protein about 0.43%; sunflower oil about 4.25%; gellan gum about 0.64%, tapioca syrup about 2.13%; lecithin about 2.34%; table salt about 0.21%, black salt about 0.13%, onion powder about 0.78%, potassium sorbate 0.26%, sodium benzoate about 1.81%, tricalcium phosphate about 1.81%, yeast extract about 0.21%; water 72%; Transglutaminase enzyme about 0.002% and branched chain amino acid about 0.21 mg.

10. The plant-based egg liquid formulation as claimed in any one of claims 1-9, wherein the said formulation is stable at 40° C. for at least 60 days.

11. A method of preparing plant-based egg liquid formulation as claimed in claim 1, wherein the said method comprising the steps of:
a. mixing of at least two plant proteins, optionally with enzyme, micro-nutrient, colorant and preservative to form a blend.
b. adding water/lentil water, emulsifier, edible oil and taste enhancer to above blend to obtain further blend.
c. adding mixture of salts to the further blend of step (b) and adjust the pH between 6.8 to 8.
d. homogenizing after step (c) under 500 to 6000 psi to reduce the particle size, followed by further processing to obtain the plant-based egg liquid formulation.

12. The method as claimed in claim 11, wherein further processing under step (d) comprises pasteurization of the liquid to 72-85° C., followed by cooling the liquid to 4-8° C. and ageing for 24-72 hr.

13. The method as claimed in claim 11, wherein the homogenization under step (d) is high sheer and/or two-step slow homogenization and performed for 2 to 60 mins.

14. The method as claimed in any one of claim 11 or 13, wherein the homogenizing is carried under 3000 to 4000 psi.

15. The food product comprising the plant-based egg liquid formulation as claimed in any of the claims 1-10, wherein the food products are selected from baked food product, sauce, dressing, mayonnaise, custard, scramble, omelette, ice cream, pasta, burger, patty, and certain other dishes.

16. The plant-based egg liquid formulation as claimed in any of the claims 1-10, wherein the formulation is an egg substitute in food products.
